(19) United States
(12) Patent Application Publication
(10) Pub. No.: US 2005/0004919 A1
(43) Pub. Date: Jan. 6, 2005

(54) Systems, methods, and computer program products providing a generalized inventory system

(75) Inventors: Richard Green, Chelan, WA (US); Donald Jebo, Fort Worth, TX (US); Peter Comiskey, Grapevine, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Sabre, Inc.

(21) Appl. No.: 10/613,923

(22) Filed: Jul. 3, 2003

(51) Int. Cl. G06F 17/00

(52) U.S. Cl. 707/100

(57) ABSTRACT

The present invention provides systems, methods, and computer program products for maintaining a product inventory. The present invention provides various control information and marketing control information that allows a user/seller to define the product, as well as the inventory and marketing controls to use with the product. In addition, the present invention provides different calculator and adjustor modules that each implement different control and inventory methodologies. The user inputs the selected control and marketing control information for a product, and selects the proper calculator and adjustor module to be used with the product. In operation, the present invention uses the controls and marketing controls input by the user, as well as the selected calculator and adjustor module to control inventory for the product. The present invention thereby allows a user to define the product and select proper controls for the product, without requiring the user to create specialized software.

### BACKGROUND OF THE INVENTION

1. Field of the Invention

The present invention relates generally to inventory management of products, and more particularly, to systems, methods, and computer program products for providing a generalized inventory system that allows different products having different inventory methodologies to be managed by a common system.

2. Description of Related Art

An important issue with regard to the sale of most products is availability and inventory management of the product. Most products have complex pricing structures, availability determination procedures, inventory management procedures, specified marketing controls, etc. These complex structures and procedures require complex computing software to properly handle administration of the product and inventory management.

For example, airline tickets include a variety of different classes that are treated differently, such as Y, B, and M classes. Further, each class of tickets may have different marketing controls, restrictions, etc. Different airlines may also use different inventory control methodologies to calculate availability of tickets, such as sub-type nesting, sub-component nesting, static virtual nesting, dynamic virtual nesting, continuous nesting, etc., and different inventory adjustment methodologies to control inventory management, such as net availability, net availability with capping, and threshold availability.

Given these complexities with inventory management of most products, many companies develop specialized software for each of their products that includes the proper classifications for the products and other information related to the product, specific software related to the selected calculating availability methodology for the product, and specific software related to the selected inventory management methodology of the product. While, these legacy software programs meet the needs for marketing, selling, and inventorying products, they are difficult to maintain and can be difficult to alter in the case that the owner wishes to change the calculator, adjustor, or marketing controls used to manage the product.

### BRIEF SUMMARY OF THE INVENTION

The present invention provides systems, methods, and computer program products that overcome many of the above-discussed disadvantages of the prior art, as well as other disadvantages not specifically mentioned herein. In particular, the present invention provides systems, methods, and computer program products for maintaining a product inventory. The present invention provides various control information and marketing control information that allows a user/seller to define the product, as well as the inventory and marketing controls to use with the product. In addition, the present invention provides different calculator and adjustor modules that each implement different control and inventory methodologies. The user inputs the selected control and marketing control information for a product. The user also selects the proper calculator and adjustor module to be used with the product. In operation, the present invention uses the controls and marketing controls input by the user, as well as the selected calculator and adjustor module to control inventory for the product. The present invention thereby allows a user/seller to define the product and select proper controls for the product, without requiring the user to create specialized software for the product. Further, it allows for easy alteration of the product information and/or inventory methodologies by merely reconfiguring the controls and/or calculator and adjustor selections for the product.

For example, in one embodiment, the system includes a computer readable storage medium comprising information related to at least one product and at least two calculator modules. The calculator modules each include computer instructions for implementing a different methodology of controlling inventory of the product. Importantly, one of the calculators is selected for the product.

Connected to the computer readable medium is a processing element. The processing element is responsive to requests concerning the product made by a user. If a consumer requests availability concerning the product, the processing element uses the selected calculator module to control the inventory of the product, such as provide availability information to the consumer concerning the selected product.

In some embodiments, the systems, methods, and computer program products may further include at least one adjustor module stored in a computer readable medium. The adjustor module includes computer instructions for implementing an inventory adjustment methodology. When a product is selected for addition or removal from inventory the processing element uses the adjustor module to adjust the inventory based on the methodology associated with the adjustor module.

The computer readable medium may comprise information for a plurality of products, a plurality of adjustor modules each capable of implementing a different inventory adjustment methodology and a plurality of calculator modules for controlling the inventory of the product. In this embodiment, one of the adjustors and one of the calculators are selected for each product. When a specific product is selected, the processing element using the selected calculator to provide a consumer with availability information about the product and the selected adjustor to adjust the inventory based on whether the consumer selects to purchase the product or cancels a previous order of the product.

The computer readable medium of the systems, methods, and computer program products of the present invention may include adjustor modules and calculator modules that include computer instructions implementing different methodologies. For example, the adjustor calculator may include computer instructions for implementing an inventory adjustment based on a methodology selected from the group consisting of net availability, net availability with capping, and threshold availability. The calculator adjustor may include computer instructions for implementing an inventory calculator based on a methodology selected from the group consisting of sub-type nesting, sub-component nesting, static virtual nesting, dynamic virtual nesting, and continuous nesting. In further embodiments, the calculator module may include computer instructions for implementing an inventory calculator based on a methodology selected by a user/seller.

The systems, methods, and computer program products of the present invention further include a plurality of control information stored in the computer readable medium for use in controlling the inventory for the product. For example, the computer readable medium may include control information such as product type, product name, product date, and product behavior. The product date relates to the date of use of the product. If the product is an airline ticket or hotel room, the product date defines the date that the ticket or room can be used. The product behavior includes data related to the selling/accounting characteristics of the product.

The systems, methods, and computer program products of the present invention may also include control information related to the basic elements of the product. The sub-components relate with a single product. There may be more than one sub-component for a given product, and the quantity of sub-components and the relationships between the components is based on the type of product and the inventory methodologies used for each product. Each product sub-component is identifiable based on the following list of attributes:
Visibility—Sub-component's visibility in the marketing process for the product.
Start Location—Where the product is located when picked up for use.
Stop Location—Where the product is located when it is dropped off or finished use.
Start Date—The date the product is picked for use.
Stop Date—The date the product is dropped off or finished use.
Start Time—The time of day the product is picked up for use.
Stop Time—The time of day the product is dropped off or finished use.
Component Relationship—The sub-components that this product owns
Inventory Methodology—the inventory methodology used with the product.

In addition to sub-component data, the systems, methods, and computer program products of the present invention may further include sub-type data related to each product. Sub-type information is categorized within a single identifiable product by the use of classes of identifiable categories. The categories are identified by the following characteristics:
Sub-Type Identifier—Identification value assigned to the product sub-type.
Sub-Type Controllers—Values used to allot quantities of inventory and control notification of use of the inventory.
Sub-Type Relationship—Relationship maintained between the sub-types products specified in upper and lower hierarchies, which are used during the selling or canceling of a previous sale process and enforces the inventory adjustment methodology selected for the product.

In addition to control information, the systems, methods, and computer program products may also include market control information related to each product. The market control information is used to evaluate specific requests for availability and/or purchase of a product. The purpose of the market controls is to place each marketed use of a product in relation to use of that same product in all other marketed uses. The market valuation result may be used as a direct input into the availability calculation or as an index to the product sub-type that represents the relative value of the current market request against other market requests. The final application of the market values is dependent upon the selected inventory methodology used during determination of availability.

The market control information is used to identify the use of a product within a dynamic relationship between one or more products and created at the time of sale. The market control information maintains information about the usage of the product, not the inventory control aspects of the product. The market control information is based on:
What is being used:
   Product Type—Type of product being used.
   Product Sub-Type—Sub-type of the product being used.
   Point-of-Pick-up—Market origination point.
   Point-of-Drop-off—Market destination point.
When it is being used:
   Time-of-Day—Peak v. off-peak time of day consumption of product.
   Blackout Restrictions—Exceptions (holidays, etc.) to consumption of the product.
When it is being purchased:
   Days before Use—Purchase is being made number of days before consumption.
   Time of Purchase—Time of day in which the purchase is being made.
Where the sale is being made:
   Point-of-Sale—Country, City, State, Business Entity identifying the location of the state.
   Point-of-Origin—Original point of origin for the consumer.
   Point-of-Destination—Final point of destination for the consumer.
How is it being used:
   Length of Use—How long the product is being used for.
   Quantity of Use—How many are being purchased (one or more)
   Sub-Type Category—Quality/value level within the product being purchased.
Market Value—A weighted value of the requested market against all other markets for use in the inventory methodology calculations.

In operation of the systems, methods, and computer program products of the present invention, when the processing element receives a request from a consumer concerning a product, the processing element retrieves the calculator module associated with the product, as well as the various control and market information associated with the product. Based on this information, the calculator module implements the control methodology stored therein to provide the consumer with availability of the product. If the consumer selects to purchase the product or cancels a previous order of the product, the processing element retrieves the adjustor module associated with the product. The processing element uses the computer instructions stored therein to adjust the inventory for the product using the selected inventory methodology.

These and other aspects of the present invention are discussed in greater detail below.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a typical network environment in which the systems, methods, and computer program products may be implemented according to one embodiment of the present invention.

FIG. 2 illustrates storage of various information and software related to the present invention in a server according to one embodiment of the present invention.

FIG. 3 is a diagram illustrating the product control relationship information used by the systems, methods, and computer program products according to one embodiment of the present invention.

FIG. 4 is a diagram illustrating product and sub-component information for an airline inventory.

FIG. 5 illustrates an example of a hybrid nesting methodology comprising serial and parallel nesting used to inventory products.

FIG. 6 illustrates a parallel nesting methodology used to inventory products.

FIG. 7 is an illustration of the operation flow of the systems, methods, and computer program products in response to a consumer availability request according to one embodiment of the present invention.

FIG. 8 is an illustration of the operation flow of the systems, methods, and computer program products in response to a consumer availability request and subsequent purchase of a product according to one embodiment of the present invention.

FIG. 9 is a diagram illustrating the product control relationship information for an airline ticket inventory used by the systems, methods, and computer program products according to one embodiment of the present invention.

FIG. 10 is an illustration of the operation flow of the systems, methods, and computer program products in response to a consumer availability request for an airline reservation according to one embodiment of the present invention.

FIG. 11 is an illustration of the operation flow of the systems, methods, and computer program products in response to a consumer availability request and subsequent purchase of an airline reservation according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As is discussed in greater detail below, the present invention provides systems, methods, and computer program products for implementing inventory management of products. Specifically, the systems, methods, and computer program products of the present invention provide a generalized inventory management system that allows a wide variety of different products to be managed without requiring specific software programming for each product. Instead, the systems, methods, and computer program products of the present invention provide a structure in which control information related to a product and marketing control data for a product can be entered and saved. The systems, methods, and computer program products also include modules for each calculator and adjustor methodology that is generally used with most products. During set-up a specific calculator and adjustor module is associated for the product. The entered control information and marketing control information further define the methodology to be used to control and manage the product in inventory. As such, during operation, a processing element uses the stored product and marketing control information to operate the selected calculator and adjustor modules selected for the product in order to provide product availability to a consumer, as well control inventory based on whether the consumer purchases and/or cancels a previous purchase of the product.

Importantly, the systems, methods, and computer program products of the present invention allow the user/seller to customize the inventory and marketing controls for each product. The customization occurs through the input of control and market control information, as well as selection of the calculator and adjustor modules. For example, even though two unrelated products use the same calculator and adjustor modules, the products may be completely different in terms of inventory management, because of the different control and market control data entered for the product that is used by the calculator and adjustor modules to implement availability calculations and inventory adjustments. These various aspects of the present invention are discussed below.

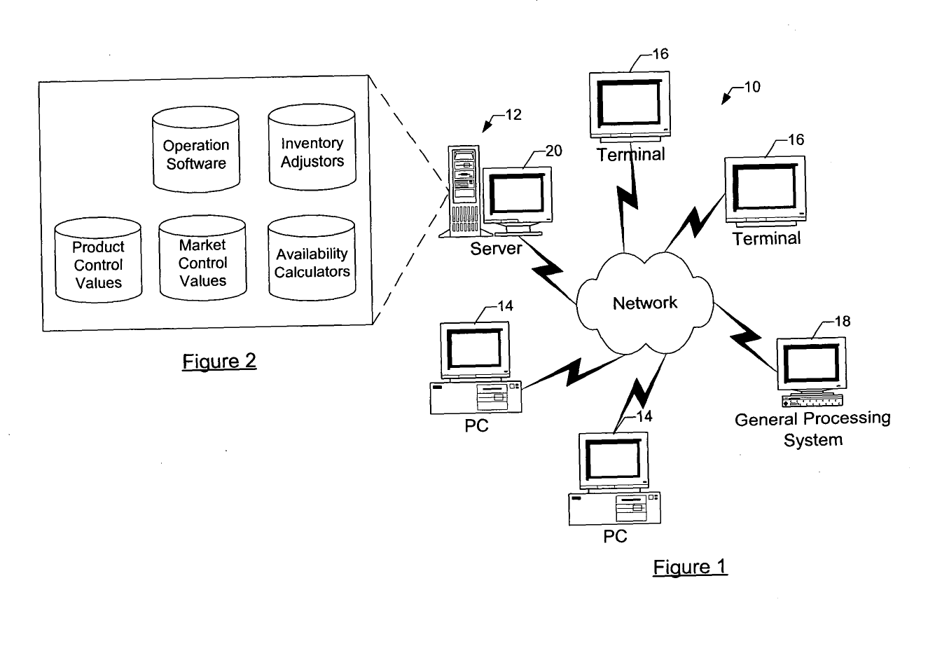

As background, FIG. 1 illustrates a typical environment in which the systems, methods, and computer program products of the present invention may be implemented. Specifically, FIG. 1 is a generalized illustration of a network 10, such as a local area network (LAN), wide area network (WAN), and/or Internet environment. As illustrated the network may contain, one or more servers 12 and one or more processing systems, such as personal computers 14, terminals 16, and/or dedicated processing systems 18. (It should be noted here that although the present invention is illustrated in a network setting, that the systems, methods, and computer program products could all operate on one computing system.). In general, the various product and market control information for the products managed by the system is stored in databases on the server 12. The calculator and adjustor modules may also be stored in databases on the server 12 or may be located in another storage device, which is accessible to a processing element implementing the systems, methods, and computer program products of the present invention.

As will be discussed, the seller of the products typically input the product and market control information, as well as selection of the calculator and adjustor modules to use with each product. This input of information may be performed in various ways. Specifically, the user/seller may use a computer 20 directly connected with the server to input the information or the user may use one or more of the personal computers 14, terminals 16, and/or dedicated computing systems 18, which are connected to the server via the network to enter the data.

The computer program instructions for implementing the system may also be stored at one or more places and implemented by one or more of the processing elements in the network. In typical applications, the software is located on the server 12 and ran by either the computing system 20 directly connected to the server or one of the other computing systems, 16 or 18, located on the network. Typically, a consumer uses one of the personal computers 14, terminals 16, and/or dedicated processing systems 18 located on the network to supply product requests and commands and information for purchase of products and/or cancellation of a previously purchased product. In the case of an Internet connection, the consumer is typically provided with information from the system in the form of a webpage and typically submits requests and other information via webpage forms. Where an Internet connection is not used, interface software may be used to display information to the consumer and receive requests and commands therefrom.

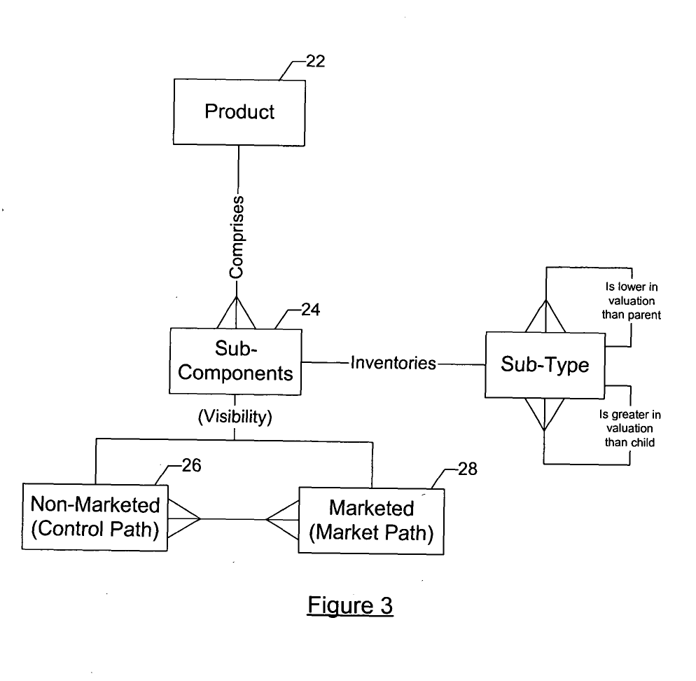

FIG. 2 is a generalized view of the type of information and data stored for a given product. Specifically, the figure illustrates the storage of data for a given product in the server 12. While not illustrated, it is understood that the same types of information will be stored for each product managed by the systems, methods, and computer program products of the present invention. Also stored in the server are the various software modules for implementing the different calculators and adjustors. These will be discussed later below. It is understood that the various data and programs illustrated in FIG. 2 as being stored in one server may instead be stored on different servers, different computing systems, different media, etc. For example, the product information could be stored on a server and the computer programs, calculators, and adjustors could be stored in another location.

As should be apparent from this disclosure, the systems, methods, and computer program products of the present invention provide a general inventory system that allows a seller to merely enter in all data related to a product and market controls related to the product and select a calculator and adjustor module for use in controlling the inventory of the product. The seller may use the system for a wide variety of products in this manner, without requiring that the seller create specialized programming to control availability and inventory controls for the product. Further, the systems, methods, and computer program products of the present invention can be used by a seller to control and adjust inventory for a plurality of products. Further, the seller may link products together in specialized packages to create a bundled package of products.

As an example, the systems, methods, and computer program products of the present invention allows a seller to inventory a car part individually. However, through the types of information stored in the system for the motor part, and especially the relationship information, all parts of a motor may be separately inventoried, but can be linked together so as to also market and sell a complete car engine.

The same could be said for travel information. The systems, methods, and computer program products of the present invention allow for separate inventory of airline tickets, hotel rooms, car rentals, etc. But through the different types of information stored with each product, the systems, methods, and computer program products of the present invention also allow these items to be linked to thereby provide a travel package to a consumer including any possible discounts that may be offered by the seller for purchase of a travel package.

These advantages are realized in part by the product, marketing, and control information that the user/seller is asked to enter for each product, as well as the selection of the desired calculator and adjustor to operate on the data. These items allow the user/seller to customize the systems, methods, and computer program products of the present invention for each product.

An initial step in the use of the systems, methods, and computer program products of the present invention is to enter the control and market control information related to the product into the system. It is important to note here that there are two types of data used in the present invention: persistent and transient data. Persistent data is the stored data concerning a product that does not change based on consumer queries, while transient data are values concerning a specific request from a consumer that are applicable only for the life of the product availability and/or product purchase request by the consumer.

The systems, methods, and computer program products of the present invention also include two different types of information: control information and market control information. Control information relates to information used to control availability requests and purchase requests for a product. Market control information is used to evaluate a specific availability and/or purchase or cancellation of a previous purchase of a product. These types of information provide the mechanisms that allow the user/seller to customize the systems, methods, and computer program products of the present invention for a specific inventoried product.

I. Control Elements

Control elements are used to establish the scope and working boundaries of the inventory system for a given product. Control elements include both persistent data related to the product used to manage inventory states across multiple requests for the product and transient data used to define the consumer and product being requested for a consumer query.

A. Product Controls

Product controls define various features of the product used for management of the inventory of the product. The product control information is typically persistent data and outlines the basic components of the product, as well as its locale in time and location. The product controls determine where the product is located, whether it moves, when it can be used (date and time), and when it expires. The product controls are listed and described below. FIG. 3 illustrates the interrelationship of the various control values used for a given product.
1. Product Type

This information outlines the type of product being inventoried. For example, the type would include information such as airline flight segment, hotel room, rental car, concert ticket, restaurant table, etc. It is important to note here that a product is typically inventoried in terms of units. For example, an airline flight is inventoried as a leg of a flight, as opposed to a flight segment. Similarly, hotel rooms are inventoried as individual rooms, car rentals as individual cars, concert tickets as individual tickets, etc.
Product Name

This control lists the name of the product. For example, a flight leg may be listed by its flight number, such as FLTAA50, a car rental may be listed by its car category, (e.g., ECAR), a restaurant table by its table number, etc.
Product Date

This is the date for which the product can be purchased, such as a date of availability for a hotel room or a date for a flight. It is noted here, that not only is each room of a hotel or each flight leg treated as a separate product, these items are further segmented into days of use. It is noted that some products may be segmented even further. For example, a car rental may be segmented into half days of use or hours of use.
Product Behavior

Product behavior lists the selling/accounting characteristics of the product, which are used by the calculator and adjustor to determine availability of a product and control inventory of the product. This information typically relates to the behavior aspects of the product. For example, a hotel room typically has a capacity of either 2 or 4 guests. This information would be stored in the product behavior. If a hotel has a capacity of 4 guests, but a requests is made for a group of 5 guests, the system will know to inquire for two rooms as opposed to one room. Similar issues would be raised for a restaurant table or a round of golf. If a table has a capacity for 4 people, but the reservation is for 6, then the system knows that two tables must be set aside for the reservation. Product behavior may also be affected by time of use. For example, a train compartment may accommodate 6 people in the daytime, but only 2 for sleeping purposes at night. This behavioral information will be used in conjunction with a time-of-day to determine what the capacity of the train compartment will be for a given segment.

As known to those skilled in the art, product behavior models can be complex based on the particular product and that the present invention is not limited to data related to capacity issues for a product, but instead, may encompass a wide variety of product behavior data.
2. Sub-Component

As illustrated in FIG. 3, each product 22 may be further defined by product sub-components 24, which are the basic elements of an inventoried product offering. These sub-components relate within a single inventoried product and may or may not be visible on their own as a marketed offering. Each product sub-component is identifiable based on the following listed attributes. There may be more than one sub-component for each product. The quantity of sub-components and their inter-component relationship is entirely driven by the type of product and inventory methodology used.
a. Visibility—

As illustrated in FIG. 3, each sub-component has visibility information. The visibility information defines whether the subcomponent is a non-marketed 26 or a marketed 28 sub-component. The Visibility information describes whether the product sub-component is visible in the marketing process.

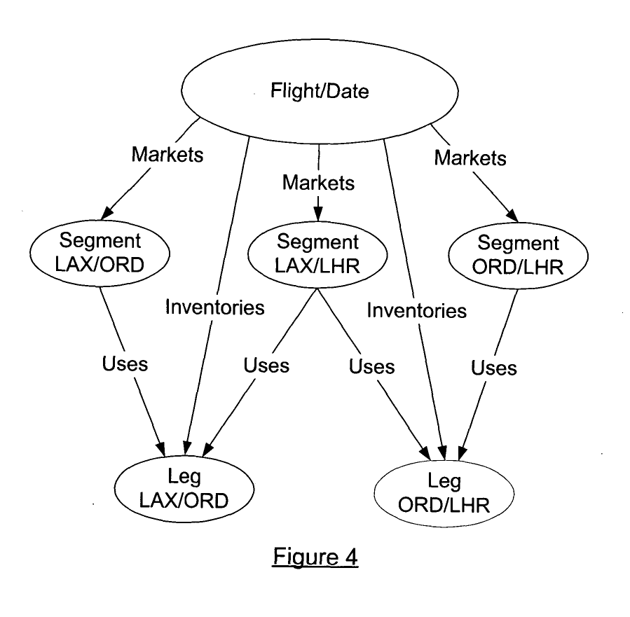

An example of this concept is illustrated in FIG. 4, which shows marketing of airline ticket inventory. Importantly, most airlines do not market the legs of a flight, instead a consumer is only provided with marketing information concerning a flight segment, which may be made up of one or more flight legs. FIG. 4 illustrates three flight segments, namely Los Angeles (LAX) to O'Hare International Airport (ORD), Los Angeles (LAX) to London-Heathrow (LHR), and O'Hare International Airport (ORD) to London-Heathrow (LHR). As further illustrated, both the LAX/ORD and LAX/LHR flight segments use the flight leg LAX/ORD and both the LAX/LHR and ORD/LHR flight segments use the flight leg ORD/LHR.

In the inventory example shown in FIG. 4, the flight legs are listed as inventory. Specifically, these are the actual units sold to the consumer to make up the flight segment marketed to a consumer. The flight segments are not inventoried items, as there is no physical unit making up the flight in inventory. Instead the flight segments are marketing controls that use the flight legs stored in inventory to create the marketed flight segment.

It is understood that FIG. 4 provides only an example of an inventory scheme. Some inventory schemes inventory both flight legs and flight segments or just flight segments.
b. Start Location—Where the product is located when picked up for use.
c. Stop Location—Where the product is located when it is dropped off or finished use.
d. Start Date—The date the product is picked for use.
e. Stop Date—The date the product is dropped off or finished use.
f. Start Time—The time of day the product is picked up for use.
g. Stop Time—The time of day the product is dropped off or finished use.
h. Component Relationship—

The sub-components that this product owns. Some of the sub-components are used for control and some for marketing. For example, for airline tickets both legs and segments are sub-components. The leg is a control sub-component as it is used by the calculator and adjustor to access availability and control inventory. The segment includes sub-component relationships with the legs. The segment either owns or uses the legs of the flight. In the sense of marketing, the legs are used when marketing the segment to indicate that such flights are possible. However, the legs are owned by the flight/date and are used by the availability calculator and adjustor to determine available inventory and revise inventory based on sales and/or cancellation of marketed segment tickets.
Inventory Methodology—

This information indicates to the system what calculator and inventory adjustor are to be used for the sub-component. The various calculator and inventory adjustor methodologies are discussed later below.
3. Sub-Type

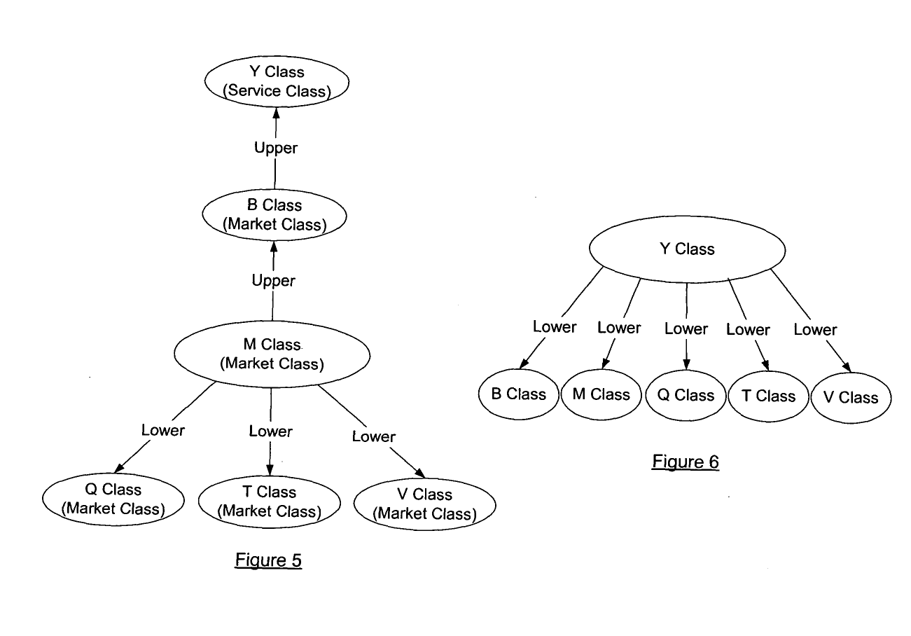

With reference to FIG. 3, sub-type control information is also used to define the product. Product sub-types are categorized within a single identifiable product by the use of “buckets” or classes of identifiable categories. These categories are identified by the characteristics listed below. The explanation of these characteristics is better understood with reference to FIG. 5. FIG. 5 illustrates an inventory hybrid nesting scheme comprising both serial and parallel nesting. As can be seen from this illustration, there are six classes of tickets: Y, B, M, Q, T, and V, with M class being the reference sub-component of interest. The Y, B, and M tickets are in a serial nesting scheme, while the Q, T, and V tickets are in a parallel nesting scheme. As illustrated, there are two classes of tickets (Y and B) above M class, each of different serial hierarchy and three classes (Q, T, V) of lower hierarchy below M class, each having the same or parallel hierarchy with respect to each other. The Y class represents the highest priced ticket, while B and M classes represent discounted tickets. The Q, T, and V classes may represent different segments of the market. For example, the T class may represent passengers traveling to a particular destination, while Q or V may represent passengers who booked the flight from a particular country.
Sub-Type Identifier—

The sub-type identifier is an identification value assigned to the product sub-type. With reference to FIG. 5, the sub-type identifier is the class code, (i.e., Y, B, M, etc.).
Sub-Type Controls—

The sub-type controls are values used to allot quantities of inventory and control notification of use of the inventory. These controls are used by the selected calculator and adjustor modules for controlling inventory. As an example, a seller may use an overbooking scheme related to the sell of tickets and typical cancellations statistics. The seller may have 20 tickets available, but may list that 30 tickets are available with the experience that typically 10 people will cancel their ticket. In this scenario, this type of information is provided in the sub-type controls. In operation, when a buyer purchases two tickets, the adjustor will subtract the 2 tickets from the 30 tickets and will indicate in the inventory 28 tickets remaining.

The inventory controls may be quite complex. In the above example, the controls may also include mechanisms that decrease the number of tickets inventoried as the event for which the tickets are sold nears. For example, at thirty days before the event, the highest availability may be set to 30, but within fives days of the event the highest availability may be reduced to 25. In the above example, if there has been two tickets sold and the date is more than five days away, the system will show an inventory of 28 tickets. However, when it is five days or less to the event, the inventory is recalculated as 23 tickets available. It is understood here that this is just one example of inventory control and that other inventory controls known in the art are also applicable for use in the systems, methods, and computer program products of the present invention.
Sub-Type Relationship—

These values describe the relationship maintained between the sub-type products specified with the upper and lower hierarchies. This relationship is used during the sale and/or cancel of products adjustment process and enforces the product sub-type's inventory adjustment methodology. The sub-type relationships categorize the sub-type based on its relationship to other sub-types of the product in order to enforce the inventory methodology selected for the product. In a nesting hierarchy, the sub-type relationship classifies sub-types as having upper hierarchy under which the current sub-type is placed within its sub-type relationship. In other words, sub-types having a hierarchy greater than the selected sub-type are categorized as upper hierarchies. For example, the Y and B classes in FIG. 5 have an upper hierarchy than the M class.

Sub-types having a lower hierarchy than the selected sub-type are classified as such. For example, classes Q, T, and V are all classified as having a lower hierarchy with respect to the M class, but the same hierarchy class with respect to each other.

It is noted here that FIG. 5 illustrates only one methodology for nesting of the various sub-types of a product. The nesting of the various sub-types is used by the adjustor methodology discussed later below to manage availability reports and inventory adjustments. The product sub-types are placed within the upper and lower sub-type hierarchies and are arranged at the time of inventory configuration. The resulting hierarchies represent the implementation of one of the following nesting configurations as it relates to the product sub-type:
No Nesting—upper and lower hierarchies are empty
Serial Nesting—upper and lower hierarchies are populate with related sub-types
Parallel Nesting—upper hierarchy has a single parent and lower hierarchy is empty
   In the instant of mixed or hybrid nesting schemes, such as the one illustrated in FIG. 5, the final implementation of a product sub-type and how the sub-type relates to other product sub-types resolves to use of one of the above hierarchy nesting methods.

As discussed later below, different adjustors, such as net availability, net availability with capping, and threshold availability, are used for different product nesting schemes. The sub-type data for each product, however, also dictates how the inventory methodology will be implemented for the product. In other words, although two separate products may use the same adjustor methodology, this methodology as applied by the adjustor module may be quite different for each product based on the control market control values provided by the sub-type control values, as these values dictate how the inventory is managed.

For example, if a threshold adjustor is used with the multiple serial nested inventory scheme described in FIG. 5, the procedure for adjusting inventory would occur as follows. If an M class ticket is sold from inventory, each of the other lower hierarchy classes Q, V, and T are decremented by 1. Further, the upper hierarchy class B is also decremented by 1. Once this has been completed for the M class ticket, the system next evaluates each of the sub-types Q, V, T, and B. Since there are no lower hierarchy types for Q, V, and T, the adjustor does nothing. However, for the hierarchy class, it will be noted that the Class B has a higher hierarchy Y. In this instance, the system will also decrement the Y class by 1.

In a different example, all of the lower hierarchy classes (B, M, Q, V, and T) may be placed in a parallel nesting, as opposed to a series nesting. In this instance, the sub-type nesting diagram would appear as shown in FIG. 6. Further, if this sub-type nesting were used with a net availability adjustor, the sale of an M class ticket would cause the M class ticket to be decremented by 1 and the Y class to be decremented by 1. However, the remaining classes would not be affected.

As an alternative to nesting, a bid price scheme could be used in which only one class (i.e., Y class) is used. In this inventory methodology, the acceptable price charged for each ticket is based on the remainder of tickets in inventory. For example, at the beginning of the offering, the acceptable price per ticket is set at a lower amount. As each ticket is sold, the acceptable price per ticket increases until the acceptable price per ticket reaches a maximum value supported by the market.

As should be apparent, the systems, methods, and computer program products of the present invention allow a user/seller to define the specifics of the availability calculation, inventory management, and marketing for a product by providing the correct data for the Product, Sub-Component, and Sub-Type fields and selecting a desired calculator and adjustor module to control inventory of the product. Specifically, FIG. 3 is a diagram illustrating a generalized product control for a product entered by a seller into the system. As illustrated, the control components form abstract relationships between each other for a generalized implementation of an inventory control mechanism. The arrangement of the generalized relationships is driven by a specific product's need to form the characteristics of control that the product uses. Importantly, the control component variations within each inventory control methodology for a given product are stored within component relationships, (i.e., Product, Sub-Component, and Sub-Type information), for the product. Therefore, generalized components, such as the calculators and adjustors are not hard coded for an individual product, but instead remain generic for all products that may be used with the system. This therefore allows the system to be arranged for an instance of use, where the specifics for control of each product are stored with the product and a generiticized calculator and adjustor are used to control the inventory of the product using the specifics associated with each product.

B. Market Controls

Market controls are different from product controls in that they evaluate a specific request for availability and/or purchase of a product from a consumer. The purpose of the market controls is to place each marketed use of a product in relation to the use of the product in all other marketed uses. In other words, the product controls are used to ensure availability and inventory adjustments based on sale of products to ensure that the product is properly inventoried, while market controls ensure that the product is sold at a market rate and that the product is not being undervalued in the market. The market valuation results may be used as a direct input to the availability calculator module or as an index into a product sub-type that represents the relative value of the current market request against those of other market requests. The final application of the market values is dependent upon the inventory control methodology used during determination of inventory availability.

A market control item is generally used to identify the use of a product within a dynamic relationship between one or more products. A market control maintains information about the usage of a product, not the inventory control aspects specific to a product. The market controls contain the following categories of information:
What is being used:
   Product Type—Type of product being used.
   Product Sub-Type—Sub-type of the product being used.
   Point-of-Pick-up—Market origination point.
   Point-of-Drop-off—Market destination point.
When it is being used:
   Time-of-Day—Peak v. off-peak time of day consumption of product.
   Blackout Restrictions—Exceptions (holidays, etc.) to consumption of the product.
When it is being purchased:
   Days before Use—Purchase is being made number of days before consumption.
   Time of Purchase—Time of day in which the purchase is being made.
Where the sale is being made:
Point-of-Sale—Country, City, State, Business Entity identifying the location of the state.
   Point-of-Origin—Original point of origin for the consumer.
   Point-of-Destination—Final point of destination for the consumer.
How is it being used:
   Length of Use—How long the product is being used for.
   Quantity of Use—How many are being purchased (one or more)
   Sub-Type Category—Quality/value level within the product being purchased.
   Market Value—A weighted value of the requested market against all other markets for use in the inventory methodology calculations. The mark value is weighted against all other markets using the same or similar products. Up-sell/down-sell adjustments may be applied to the value to compensate for other market forces.

C. Transient Controls (non-persistent data)

Transient controls relate to a specific inventory request made by a consumer. Transient controls are values concerning a consumer request that are applicable only for the life of the availability query and/or purchase or cancel of product. Transient controls are taken into account as part of the calculation of available product inventory and therefore form an integral part of the inventory control methodology. The information within a transient request includes the following values:
1. Requested Product—

This includes information specific to the identification of the product being requested and the longevity of the consumer's use of the product. These values are within each request and form the basis in determining: who is selling what product for consumption where and when into the future?
2. Control Values—

This includes information specific to the value of the request. These values are used in the evaluation of the request and calculation of available capacity. These values are used by the value based inventory methodologies.

II. Determination Elements (Process Elements)

As discussed above, the seller of the product input the various control and market control information for a product. The user/seller next selects an appropriate calculator and adjustor module to apply the desired inventory control methodology to the product. The determination elements are used to implement an availability calculation and inventory adjustment for an inventoried product within the scope of a specific inventory control methodology. These determination elements use both persistent and transient data values within the control elements discussed above. The information within the control elements may vary based upon the inventory control methodology supported by the determination elements (i.e., availability calculator and inventory adjustor) selected for the product.

Determination elements come in the following forms:
Calculators—Used to calculate the level of product availability based on an availability request.
Adjustors—Used to adjust inventory based on either a sale of the product or cancellation of a previous sale of the product.
   Calculators and adjustors are established and used in pairs. The calculator/adjustor relationship is used as a predefined one to one relationship in support of an inventory control methodology selected by the user for the product. However, it is understood that the seller may select different combinations of calculators and adjustors depending on the desired inventory management for the product. The calculators and adjustors are discussed in turn below.

A. Calculators (Availability Determination)

Calculators are used to apply an inventory control methodology against transient and persistent control elements. Calculators determine the level of available inventory for both a shopping (browsing) and selling process. Importantly, the systems, methods, and computer program products provide various generic calculators that implement known inventory methodologies typically used by seller. However, it must be understood that the systems, methods, and computer program products of the present invention also envision the use of user definable calculators that implement inventory methodologies that are specifically designed by the user for a product. Some of these calculators are listed below. It is understood that this is a representative sample of the different types of calculators and the present invention is not limited to the calculators listed herein.
1. Sub-Type Nesting Calculator—A calculation method uses sub-type values contained within a single product sub-component to perform availability calculations for a consumer.
2. Sub-Component Nesting Calculator—A calculation method uses sub-type values contained within one or more sub-components to perform availability calculations for a consumer.
3. Static Virtual Nesting Calculator —A calculation method that uses a static value based grading system against consumer requests to index and evaluate product allotments when determining availability. Higher value consumers index into higher value product sub-types and quantities of available inventory. The static nature of this process is due to all consumers receiving the same value when requesting the same product.
4. Dynamic Virtual Nesting Calculator —A calculation method that uses a dynamic value based grading system against consumer requests to index and evaluate product allotments when determining availability. Higher valued consumers dynamically index into higher value product sub-types and quantities of available inventory. The dynamic nature is driven by varying elements of the consumer's value when requesting the same product.
5. Continuous Nesting Calculator—A standard bid calculator. The calculator uses market values to enforce the expected revenue for the product against the value of the consumer. This calculator creates a hurdle price that the consumer must pay for dynamic combinations of offered product. The combinations of product are unknown and limitless until defined at the time of availability.
6. User Definable Calculators—Users (product sellers) of the present invention may wish to define their own maintainable calculators based on their own methodologies. In this instance, users may choose to implement private or smart calculators such as:
   a. Rules Engine (Artificial Intelligence) Calculators—A rule-based calculator that used artificial intelligence to implement inventory calculations. This method provides the inventory user (seller) with the ability to quickly react to market changes and the ability to redefine the calculation routine to meet market needs.
   b. Black Box Calculators—A calculation routine that is supplied by the user and produces an available capacity per offered product/component/sub-type product. This calculator's method of determination is specific to the user.
7. Custom Calculators—Specialized versions of the generic calculators.

B. Adjustors (Account for Sale or Cancellation of Product)

Adjustors are used by the systems, methods, and computer program products of the present invention to count sales or cancellations of sales against inventory. Adjustors use the product sub-type relationship to determine which of the following methods to use when adjusting a product and/or product sub-type within a value based hierarchy:
1. Net Availability—This adjustor causes all product sub-types (fare classes or buckets) of greater value within a product sub-type's hierarchy to be adjusted.
2. Net Availability with Capping—This adjustor uses the Net
   Availability method to adjust quantities. Once all greater value sub-types are adjusted, each greater value sub-type is policed to ensure it's owned lesser value sub-types have lower availability than itself. Capping is used to ensure that no lesser value product sub-type exceeds availability of a greater value sub-type.
3. Threshold Availability—This adjustor causes all greater or lesser value product sub-types (fare classes or buckets) within a product sub-type's nesting hierarchy to be updated.

C. Substitutable Elements

The user may choose to substitute the calculator and adjuster provided by the systems, methods, and computer program products of the present invention with custom implementations in support of a new method of inventory management envisioned by the user. In this instance, the substituted modules would be added to the system and used in place of the calculators and adjustors.

III. System Operation

As illustrated in FIG. 2, the systems, methods, and computer program products of the present invention allow a user/seller to enter various product control information related to a product and select an appropriate calculator and adjustor for inventory management of the product. Following setup, the systems, methods, and computer program products of the present invention receive requests from consumers concerning availability of the product, as well as orders or cancellations for the product. Based on consumer input, the systems, methods, and computer program products of the present invention provide the consumer with availability information, transact sales of the product, and adjust inventories for the product appropriately.

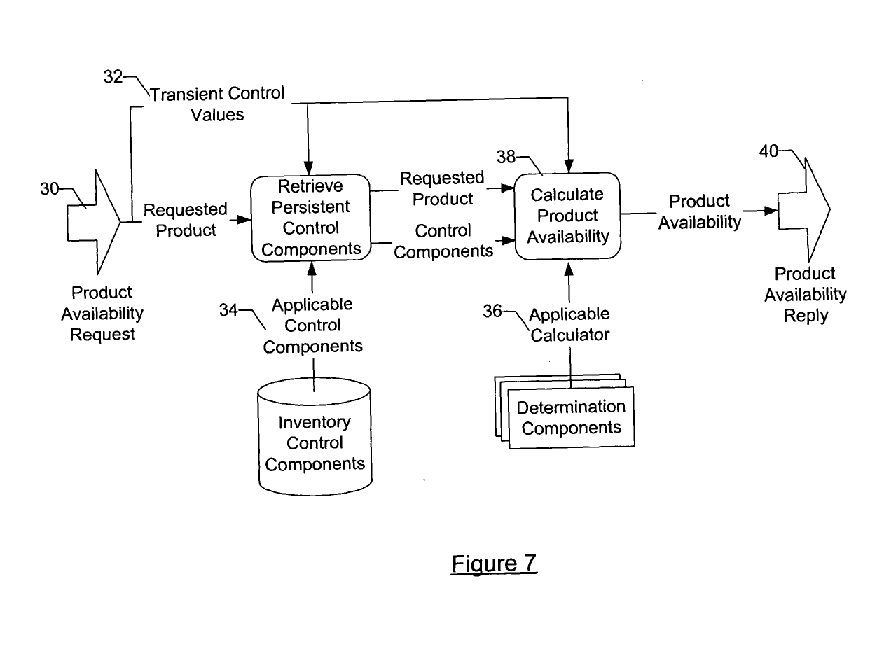

FIG. 7 is an illustration of the operation flow of the systems, methods, and computer program products in response to a consumer availability request. As illustrated, the systems, methods, and computer program products of the present invention initially receive an availability request 30 from a consumer. Based on the selected product, the system retrieves the calculator module that was preselected by the user/seller for inventory control of the product. The calculator module uses transient control values 32 received from the consumer's request and also retrieves the persistent control components 34 related to the product from the memory of system. Using information related to the requested product, persistent control values, and transient control values, the system uses the selected calculator 36 to determine the availability 38. This availability information is then passed to the consumer 40.

As discussed previously, the availability calculation methodology is dependent upon the inventory methodology selected by the user/seller at the time of configuration. The calculator uses both the transient control values 32 provided by the consumer representing the request, as well as persistent control values 34 stored by the user/seller for the product. The persistent control elements used in the availability determination are tied to the selected calculator. In this regard, Table I below illustrates the different types of data and the calculator typically selected for each inventory methodology.

TABLE I

| | Product | Market | Transient | |
|---|---|---|---|---|
| Inventory Methodology | Controls | Controls | Controls | Calculator |
| Sub-Type Nesting | Yes | No | No | Sub-Type Nesting |
| Sub-Component Nesting | Yes | No | No | Sub-Component |
| | | | | Nesting |
| Static Virtual Nesting | Yes | Yes | No | Static Virtual Nesting |
| Dynamic Virtual Nesting | Yes | Yes | Yes | Dynamic Virtual |
| | | | | Nesting |
| Continuous Nesting | Yes | Yes | Yes | Continuous Nesting |
| Black Box | Yes | Yes | Yes | User Supplied |
| Rules Based | Yes | Yes | Yes | Rules Engine (AI) |
| Other | Yes | Yes | Yes | Custom |

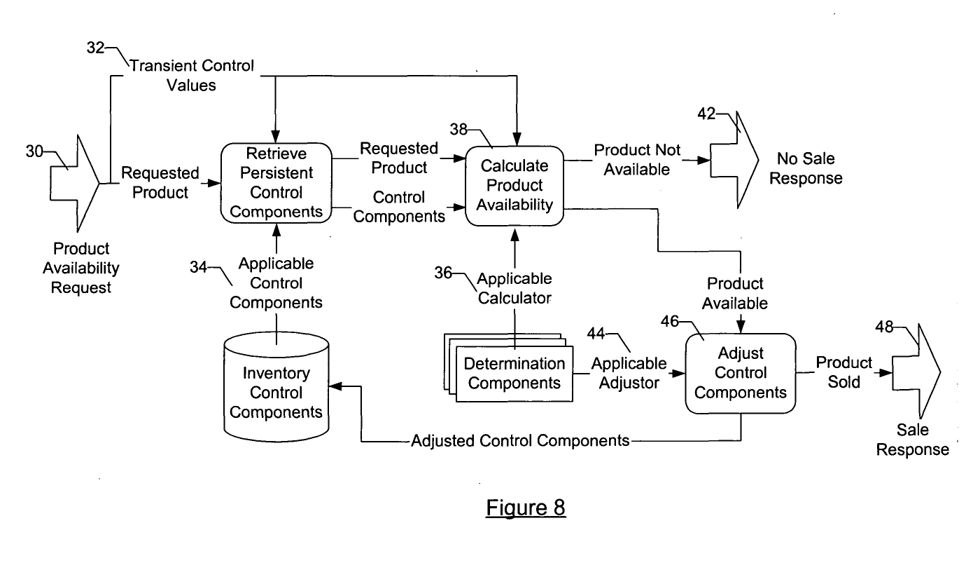

In addition to determining availability or in lieu of first determining availability for a product, the consumer may choose to purchase the product. FIG. 8 illustrates the operations performed by the systems, methods, and computer program products when a consumer decides to purchase a product. As discussed with reference to FIG. 7, the systems, methods, and computer program products initially determine availability for the product when a product has been selected for purchase. Note that these steps are done even if the consumer initially requested availability information because in the time between the consumer's initial request for availability information and the time consumer actually selects to purchase the product, availability for the product may have changed. For example, if the consumer performed a product availability request and the calculator determined that only one of the product was left in inventory, by the time the consumer selects to purchase the product, another consumer may have already selected to purchase the product. Thus, the availability calculation must be reran to ensure that the product is still available for purchase.

If the product is not available, the system will display a notice 42 to that effect to the consumer. However, if the product is available and the consumer selects to purchase the product, systems, methods, and computer program products of the present invention retrieve the selected adjuster 44 from the memory and count the sell 46. The product is displayed to the consumer as a completed transaction 48, and the adjustor adjusts the inventory to account for the sell.

Specifically, the inventory mechanism of the present invention is optimized to enable rapid availability calculations and adjustments. The lesser active sell/cancel operation is used to tally current inventory states for each product type and provide accurate availability at each product point. This, in turn, allows the system to return availability in a single product read operation. When a product is determined to be available, the product's Sub-Type Relationship attribute is used to identify the application adjustor to be used for inventory control. The adjuster performs adjustments based upon the adjustor's implemented inventory methodology. The following product control components may be manipulated:
The active product component for the product.
Each child sub-component of the active product.
   Within the product component and its child sub-components:
The sold/cancelled product sub-type.
Each of the related sub-type products specified within the upper and lower hierarchies.

As discussed previously, the adjustor methodology is dependent upon the inventory methodology selected by the user/seller. The adjuster uses both the transient control values 32 provided by the consumer representing the request, as well as persistent control values 34 stored by the user/seller for the product. The persistent control elements used in the availability determination are tied to the selected adjustor. In this regard, Table II below illustrates the different types of data and the calculator typically selected for each inventory methodology. It is noted here that activation of the adjustor only occurs when the calculator determines that the product is available during a sale request or during a cancellation of the product. Only one adjustor is typically used against a single product sub-type to count the sale or cancellation of the inventory. The product sub-types modified by the adjustor are identified by those referenced within the Product Sub-Type Relationship attributes of the product sub-type being sold.

TABLE II

| Inventory | Product | Market | Transient | | |
|---|---|---|---|---|---|
| Methodology | Controls | Controls | Controls | Calculator | Adjustor |
| Sub-Type Nesting | Yes | No | No | Sub-Type | One or |
| | | | | Nesting | More |
| Sub-Component | Yes | No | No | Sub-Component | One or |
| Nesting | | | | Nesting | More |
| Static Virtual | Yes | Yes | No | Static Virtual | One or |
| Nesting | | | | Nesting | More |
| Dynamic Virtual | Yes | Yes | Yes | Dynamic Virtual | One or |
| Nesting | | | | Nesting | More |
| Continuous | Yes | Yes | Yes | Continuous | One or |
| Nesting | | | | Nesting | More |
| Black Box | Yes | Yes | Yes | User Supplied | User |
| | | | | | Supplied |
| Rules Based | Yes | Yes | Yes | Rules Engine | All |
| | | | | (Al) | |
| Other | Yes | Yes | Yes | Custom | All and |
| | | | | | Custom |

IV. Example of Use

Provided below is an example of the systems and methods as implemented to provide a consumer with airline ticket information and purchase thereof. It is understood that this example is provided only as a way to further understand the invention and that the invention is in no way limited to the specifics of this example. The purpose of the systems, methods, and computer program products of the present invention is, among other things, to provide a generalized inventory system that allows a user/seller to enter, offer for sale, and inventory any of a number of products, such as airline tickets, hotel rooms, car rentals, restaurant reservations, golf tee times, theatre tickets, consumer goods, etc.

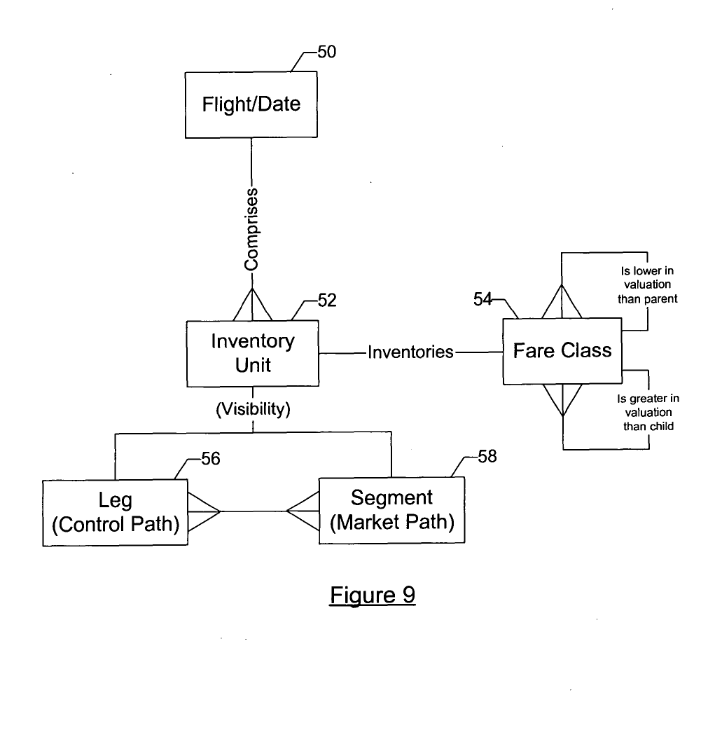

FIG. 9 is a product control relationship diagram that outlines use of the product control components in support of airline inventory. As illustrated, for a given flight/date 50, the flight/date consists of an inventory unit 52 sub-component having different fare classes 54 of tickets as sub-types. Further, as illustrated the inventory unit includes non-marketed flight legs 56 and marketed flight segments 58. More specifically, the product includes the following persistent control data:
Product—Flight/Date
Sub-Component—Inventory Unit (sub-typed into Flight Leg and Flight Segment)
Non-Marketed Sub-Component—Flight Leg (inventory only, not marketed)
Marketed Sub-Component—Flight Segment (sold but controlled by flight leg capacity)
Sub-Type within Sub-Component—Fare Classes
Sub-Type Hierarchy—nested fare class (note that this depends on the inventory methodology)
   FIGS. 3 and 4 discussed previously respectively outline the product/sub-component relationship and the product sub-type hierarchy. The methodology is continuous nesting.

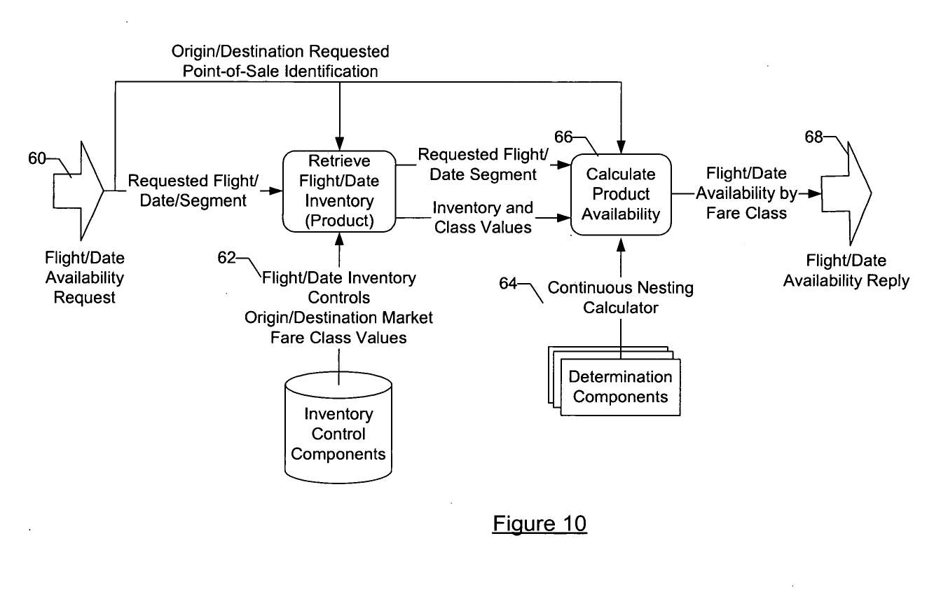

Following input of control information related to the product and selection of a calculator and adjustor, the product is then made available to the consumer. In this regard, FIG. 10 illustrates the operations followed by the systems, methods, and computer program products of the present invention in response to a consumer request for availability. As illustrated, the consumer initially inputs a request for a flight/date availability 60. The consumer input data is transient data. The flight/date information with the transient controls is used to retrieve the applicable flight date inventory records 62 from memory. The origin and destination specified by the consumer and the consumer's point-of-sale identifier (both within the transient controls) are used to retrieve each point-of-sale specific fare class and its lowest applicable selling value from the market controls within the memory. The inventory methodology specified within the retrieved Flight/Date inventory record is used to identify the correct calculator 64 to use with the product, (in this case, the continuous nesting availability calculator). The calculator next determines 66 the available seat capacity for each applicable fare class value passed to it from the market controls. The availability is then returned to the consumer 68.

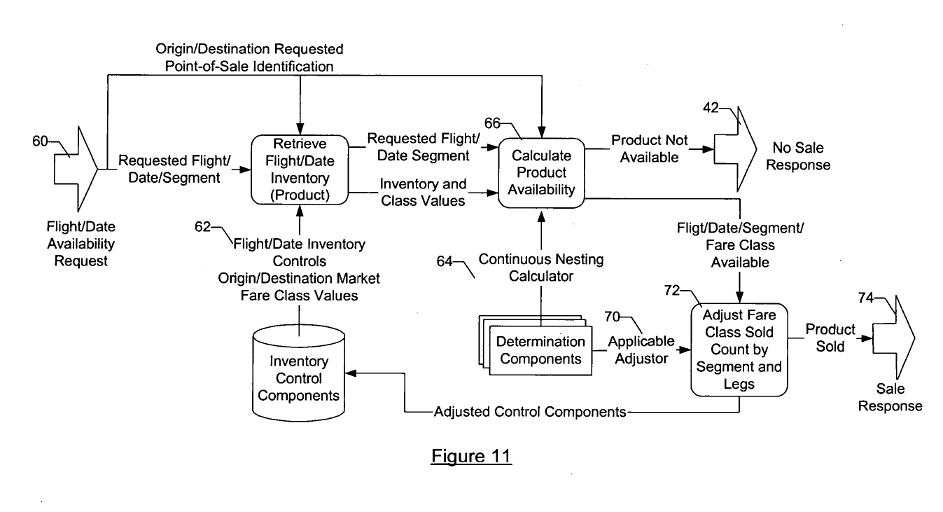

FIG. 11 illustrates the operations performed by the systems, methods, and computer program products when a consumer user decides to purchase a product. As discussed with reference to FIG. 10, the systems, methods, and computer program products initially determine availability for the product when a product has been selected for purchase. Note that these steps are done even if the consumer initially requested availability information because in the time between the consumer's initial request for availability information and the time consumer actually selects to purchase the product, availability for the product may have changed. For example, if the consumer performed a product availability request and the calculator determined that only one of the product was left in inventory, by the time the consumer selects to purchase the product, another consumer may have already selected to purchase the product. Thus, the availability calculation must be reran to ensure that the product is still available for purchase.

As illustrated in FIG. 11, a continuous nesting adjustor is used for inventory control. After the availability calculator has determined the availability for the airlines tickets, the adjustor selected for the product, (i.e., the continuous nesting adjustor), is retrieved 70. The adjustor is applied against the Flight/Date/Segment controls to tally the sale action and flight/date leg controls are adjusted to manage the sale 72. All fare classes of upper and lower value within the requested fare class' hierarchy are adjusted using the adjuster. A sold response is then returned to the consumer 74.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for maintaining inventory for a plurality of products comprising:
a first computer readable storage medium comprising product information fields that are configurable to define controls that are used to manage the inventory of a product;
a second computer readable storage medium comprising at least one calculator module comprising computer instructions for implementing a methodology for controlling inventory of the product;
a third computer readable storage medium comprising at least one adjustor module comprising computer instructions for implementing an inventory adjustor methodology for the product; and
a processing element in communication with said computer readable storage medium, wherein when said product is selected, said processing element uses the information stored in the product fields, the calculator, and the adjustor to control the inventory of the product.

2. A system according to claim 1, wherein said first computer readable medium comprises product information fields that are configurable to define controls that will be used to manage the inventory of a plurality of products.

3. A system according to claim 1, wherein said first computer readable medium comprises product information fields for each of a plurality of products that are configurable to define controls that will be used to manage the inventory for each product.

4. A system according to claim 1, wherein for a product said first computer readable medium includes sub-component data related to the product.

5. A system according to claim 4, wherein the sub-component data comprises data related to whether the product is used in marketing.

6. A system according to claim 4, wherein the sub-component data includes information related to the time, date, and location where the product is used.

7. A system according to claim 4, wherein the sub-component data includes information related to an inventory methodology used for at least one of control or adjust inventory for the product.

8. A system according to claim 4, wherein the sub-component data includes information related to relationships with other sub-components of the product.

9. A system according to claim 4, wherein for a product said first computer readable medium includes sub-type data related to the product sub-component.

10. A system according to claim 9, wherein said sub-type data comprises an identification value assigned to the product sub-component.

12. A system according to claim 9, wherein said sub-type data comprises values to allot quantities of inventory and control notification of use of the inventory.

13. A system according to claim 9, wherein said sub-type data comprises values representing hierarchy under which the product sub-type is placed relative to other product sub-types, wherein said values are used during a sell or cancel adjustment to the inventory of the product.

14. A system according to claim 1, wherein for a product said first computer-readable medium includes market control information.

15. A system according to claim 14, wherein said market control information is selected from the group consisting of identification of the product, when the product is being used, when the product is being purchased, where the product is being sold, how the product is being used, and a market value.

16. A system according to claim 14, wherein said market control information comprises a weighted value for a requested market against all other possible markets for the product.

17. A system according to claim 1, wherein at least two of said first, second, and third computer readable mediums are comprised in the same computer readable medium.

18. A method for maintaining inventory for a plurality of products comprising:
providing product information fields that are configurable to define controls that are used to manage the inventory of a product on a computer readable medium;
providing at least one calculator module comprising computer instructions for implementing a methodology of controlling inventory of the product on a computer readable medium;
providing at least one adjustor module comprising computer instructions for implementing an inventory adjustor methodology for the product on a computer readable medium;
receiving a request for information concerning the product; and
using the information stored in the product fields, the calculator, and the adjustor to control the inventory of the product.

19. A method according to claim 18, wherein said providing product information step provides product information fields that are configurable to define controls that will be used to manage the inventory of a plurality of products.

20. A method according to claim 18, wherein said providing product information step provides product information fields for each of a plurality of products that are configurable to define controls that will be used to manage the inventory for each product.

21. A method according to claim 18, wherein for a product said providing product information step provides sub-component data related to the product.

22. A method according to claim 21, wherein the sub-component data comprises data related to whether the product is used in marketing.

23. A method according to claim 21, wherein the sub-component data includes information related to the time, date, and location where the product is used.

24. A method according to claim 21, wherein the sub-component data includes information related to an inventory methodology used for at least one of control or adjust inventory for the product.

25. A method according to claim 21, wherein the sub-component data includes information related to relationships with other sub-components of the product.

26. A method according to claim 18, wherein for a product said providing product information step provides sub-type data related to the product sub-component.

27. A method according to claim 26, wherein said sub-type data comprises an identification value assigned to the product sub-component.

28. A method according to claim 27, wherein said sub-type data comprises values to allot quantities of inventory and control notification of use of the inventory.

29. A method according to claim 27, wherein said sub-type data comprises values representing hierarchy under which the product sub-type is placed relative to other product sub-types, wherein said values are used during a sell or cancel adjustment to the inventory of the product.

30. A method according to claim 18, wherein for a product said providing product information step provides market control information.

31. A method according to claim 30, wherein said market control information is selected from the group consisting of identification of the product, when the product is being used, when the product is being purchased, where the product is being sold, how the product is being used, and a market value.

32. A method according to claim 31, wherein said market control information comprises a weighted value for a requested market against all other possible markets for the product.

33. A system for maintaining a product inventory comprising:
a first computer readable storage medium comprising information related to at least one product;
a second computer readable storage medium comprising at least two calculator modules, wherein each modules comprises computer instructions for implementing a different methodology of controlling inventory of the product, and wherein one of said calculator modules is selected to control the inventory of said product; and
a processing element in communication with said computer readable storage mediums, wherein when said product is selected, said processing element uses said selected calculator module to control the inventory of said product.

34. A system according to claim 33 further comprising a third computer readable medium further comprises at least one adjustor module comprising computer instructions for implementing an inventory adjustment methodology, wherein when a product is selected for addition or removal from inventory said processing element uses said adjustor module to adjust the inventory based on the methodology associated with said adjustor module.

35. A system according to claim 34, wherein at least two of said first, second, and third computer readable mediums are comprised in the same computer readable medium.

36. A system according to claim 34, wherein said computer readable medium comprises information for a plurality of products and a plurality of adjustor modules each capable of implementing a different inventory adjustment methodology, wherein one of said adjustors is selected for each product, and wherein when a product is selected for addition or removal from inventory said processing element uses said adjustor module associated with said product to adjust the inventory based on the methodology associated with said adjustor module.

37. A system according to claim 34, wherein said adjustor module includes computer instructions for implementing an inventory adjustment based on a methodology selected from the group consisting of net availability, net availability with capping, and threshold availability.

38. A system according to claim 33, wherein said computer readable medium comprises information for a plurality of products and a plurality of calculator modules each capable of implementing a different inventory control methodology, wherein one of said calculator modules is selected for each product, and wherein when a product is selected, said processing element uses the calculator module associated with said control module to control the inventory of said product.

39. A system according to claim 33, wherein said calculator module includes computer instructions for implementing an inventory calculator based on a methodology selected from the group consisting of sub-type nesting, sub-component nesting, static virtual nesting, dynamic virtual nesting, and continuous nesting.

40. A system according to claim 33, wherein said calculator module includes computer instructions for implementing an inventory calculator based on a methodology selected by a user.

41. A system according to claim 33, wherein for each product said computer readable medium comprises product information associated therewith selected from the group consisting of product type, product name, product date, and product behavior.

42. A system according to claim 33, wherein for a product said computer readable medium includes product behavior data related to the selling and accounting characteristics of the product.

43. A system according to claim 33, wherein for a product said computer readable medium includes sub-component data related to the product.

44. A system according to claim 43, wherein for a product said computer readable medium includes sub-type data related to the product sub-component.

45. A system according to claim 33, wherein for a product said computer-readable medium includes market control information.

46. A method for maintaining a product inventory comprising:
providing on a computer readable storage medium information related to at least one product;
providing on a computer readable medium at least two calculator modules, wherein each modules comprises computer instructions for implementing a different methodology of controlling inventory of the product, and wherein one of said calculator modules is selected to control the inventory of said product;
receiving a request for information concerning the product; and
using the selected calculator module to control the inventory of the product.

47. A method according to claim 46 further comprising:
providing in a computer readable medium at least one adjustor module comprising computer instructions for implementing an inventory adjustment methodology; and
wherein when a product is selected for addition or removal from inventory, using the adjustor module to adjust the inventory based on the methodology associated with the adjustor module.

48. A method according to claim 47, said providing steps provide a plurality of products and a plurality of adjustor modules each capable of implementing a different inventory adjustment methodology on the computer readable medium, wherein one of the adjustors is selected for each product, and wherein when a product is selected for addition or removal from inventory said using step uses the adjustor module associated with the product to adjust the inventory based on the methodology associated with the adjustor module.

49. A method according to claim 47, wherein the adjustor module includes computer instructions for implementing an inventory adjustment based on a methodology selected from the group consisting of net availability, net availability with capping, and threshold availability.

50. A method according to claim 46, wherein said providing steps provide a plurality of products and a plurality of calculator modules each capable of implementing a different inventory control methodology on the computer readable medium, wherein one of the calculator modules is selected for each product, and wherein when a product is selected, said using step uses the calculator module associated with the control module to control the inventory of the product.

51. A method according to claim 46, wherein the calculator module includes computer instructions for implementing an inventory calculator based on a methodology selected from the group consisting of sub-type nesting, sub-component nesting, static virtual nesting, dynamic virtual nesting, and continuous nesting.

52. A method according to claim 46, wherein for each product said computer readable medium comprises product information associated therewith selected from the group consisting of product type, product name, product date, and product behavior.

53. A method according to claim 46, wherein for a product the computer readable medium includes product behavior data related to the selling and accounting characteristics of the product.

54. A method according to claim 46, wherein for a product the computer readable medium includes sub-component data related to the product.

55. A method according to claim 54, wherein for a product the computer readable medium includes sub-type data related to the product sub-component.

56. A method according to claim 46, wherein for a product the computer-readable medium includes market control information.

57. A system for maintaining a product inventory comprising:
a first computer readable storage medium comprising information related to at least one product;
a second computer readable storage medium comprising at least two adjustor modules, wherein each modules comprises computer instructions for implementing an inventory adjustment methodology, and wherein one of said adjustor modules is selected to control the inventory of said product; and
a processing element in communication with said computer readable storage mediums, wherein when said product is selected, said processing element uses said selected adjustor module to control the inventory of said product.

58. A system according to claim 57, wherein said computer readable medium comprises information for a plurality of products and a plurality of adjustor modules each capable of implementing a different inventory adjustment methodology, wherein one of said adjustor calculator is selected for each product, and wherein when a product is selected for addition or removal from inventory said processing element uses said adjustor module associated with said product to adjust the inventory based on the methodology associated with said adjustor module.

59. A system according to claim 57, wherein said adjustor module includes computer instructions for implementing an inventory adjustment based on a methodology selected from the group consisting of net availability, net availability with capping, and threshold availability.

60. A system according to claim 57 further comprising a third computer readable medium further comprises at least one calculator module comprising computer instructions for implementing an availability methodology, wherein when a product is selected said using step uses said calculator module to determine availability for the product based on the methodology associated with said calculator module.

61. A system according to claim 60, wherein at least two of said first, second, and third computer readable mediums are comprised in the same computer readable medium.

62. A system according to claim 60, wherein said computer readable medium comprises information for a plurality of products and a plurality of calculator modules each capable of implementing a different inventory availability methodology, wherein one of said calculators is selected for each product, and wherein when a product is selected for an availability determination said processing element uses said calculator associated with said product to determine availability based on the methodology associated with said calculator module.

63. A system according to claim 60, wherein said calculator module includes computer instructions for implementing a product availability determination based on a methodology selected from the group consisting of sub-type nesting, sub-component nesting, static virtual nesting, dynamic virtual nesting, and continuous nesting.

64. A system according to claim 57, wherein said adjustor module includes computer instructions for implementing a product availability determination based on a methodology selected by a user.

65. A system according to claim 57, wherein for each product said computer readable medium comprises product information associated therewith selected from the group consisting of product type, product name, product date, and product behavior.

66. A system according to claim 57, wherein for a product said computer readable medium includes product behavior data related to the selling and accounting characteristics of the product.

67. A system according to claim 57, wherein for a product said computer readable medium includes sub-component data related to the product.

68. A system according to claim 67, wherein for a product said computer readable medium includes sub-type data related to the product sub-component.

69. A system according to claim 57, wherein for a product said computer-readable medium includes market control information.

70. A method for maintaining a product inventory comprising:
providing on a computer readable storage medium information related to at least one product;
providing on a computer readable medium at least two adjustor modules, wherein each modules comprises computer instructions for implementing a different inventory adjustment methodology, and wherein one of said adjustor modules is selected to control the inventory of said product;
receiving a request for information concerning the product; and
using the selected adjustor module to control the inventory of the product.

71. A method according to claim 70, wherein the computer readable medium comprises information for a plurality of products and a plurality of adjustor modules each capable of implementing a different inventory adjustment methodology, wherein one of the adjustor calculator is selected for each product, and wherein when a product is selected for addition or removal from inventory said using step uses the adjustor module associated with the product to adjust the inventory based on the methodology associated with the adjustor module.

72. A method according to claim 70, wherein the adjustor modules include computer instructions for implementing an inventory adjustment based on a methodology selected from the group consisting of net availability, net availability with capping, and threshold availability.

73. A method according to claim 70 further comprising providing computer instructions for implementing an availability methodology, wherein when a product is selected said using step uses said calculator module to determine availability for the product based on the methodology associated with said calculator module.

74. A method according to claim 60, wherein said computer readable medium comprises information for a plurality of products and a plurality of calculator modules each capable of implementing a different inventory availability methodology, wherein one of said calculators is selected for each product, and wherein when a product is selected for an availability determination said processing element uses said calculator associated with said product to determine availability based on the methodology associated with said calculator module.

75. A method according to claim 70, wherein said calculator module includes computer instructions for implementing a product availability determination based on a methodology selected from the group consisting of sub-type nesting, sub-component nesting, static virtual nesting, dynamic virtual nesting, and continuous nesting.

76. A method according to claim 70, wherein said adjustor module includes computer instructions for implementing a product availability determination based on a methodology selected by a user.

77. A method according to claim 70, wherein for each product said computer readable medium comprises product information associated therewith selected from the group consisting of product type, product name, product date, and product behavior.

78. A method according to claim 70, wherein for a product said computer readable medium includes product behavior data related to the selling and accounting characteristics of the product.

79. A method according to claim 70, wherein for a product said computer readable medium includes sub-component data related to the product.

80. A method according to claim 79, wherein for a product said computer readable medium includes sub-type data related to the product sub-component.

81. A method according to claim 70, wherein for a product said computer-readable medium includes market control information.

82. A method for maintaining inventory for a plurality of products comprising:
accessing one or more computer readable mediums that comprise:
product information fields that are configurable to define controls that will be used to manage the inventory of a product;
at least one calculator module comprising computer instructions for implementing a methodology of controlling inventory of the product; and
at least one adjustor module comprising computer instructions for implementing an inventory adjustment methodology;
inputting product information into the product information fields related at least one product; and
selecting the calculator and adjustor modules to use with the selected product.

83. A method according to claim 82, wherein the first computer readable medium comprises product information fields that are configurable to define controls that will be used to manage the inventory of a plurality of products.

84. A method according to claim 82, wherein said inputting step comprises inputting product information into the product information fields for each of a plurality of products.

85. A method according to claim 82, wherein said inputting step comprises inputting sub-component data related to the product.

86. A method according to claim 85, wherein said inputting step comprises inputting sub-type data related to the product sub-component.

87. A method according to claim 82, wherein said inputting step comprises inputting market control information.

88. A method according to claim 82, wherein the computer readable medium comprises at least two adjustor modules, wherein each modules comprises computer instructions for implementing an inventory adjustment methodology, and wherein said selecting comprises selecting one of said adjustor modules to use with the product.

89. A method according to claim 89, wherein at least on the adjustor modules includes computer instructions for implementing an inventory adjustment based on a methodology selected from the group consisting of net availability, net availability with capping, and threshold availability.

90. A method according to claim 82, wherein the computer readable medium comprises at least two calculator modules, wherein each module comprises computer instructions for implementing a different methodology of controlling inventory of the product, and wherein said selecting comprises selecting one of said calculator modules to use with the product.

91. A method according to claim 90, wherein at least one of the calculator modules includes computer instructions for implementing an inventory calculator based on a methodology selected from the group consisting of sub-type nesting, sub-component nesting, static virtual nesting, dynamic virtual nesting, and continuous nesting.
